(19) United States
(12) Patent Application Publication
(10) Pub. No.: US 2009/0034895 A1
(43) Pub. Date: Feb. 5, 2009

(54) NON-DIAMETRICAL MULTI-CONTACT BEARING

(75) Inventors: Mark ZLIPKO, St. Albert (CA); Stephen THOMPSON, Edmonton (CA)

Correspondence Address: DAVIS & BUJOLD, P.L.L.C., 112 PLEASANT STREET, CONCORD, NH, 03301, US

(73) Assignee: QA BEARING TECHNOLOGIES LTD., Edmonton (CA)

(21) Appl. No.: 12/237,641

(22) Filed: Sep. 25, 2008

(30) Foreign Application Priority Data
Sep. 26, 2007 (CA) 2603390

(51) Int. Cl. F16C 33/58

(52) U.S. Cl. 384/513

(57) ABSTRACT

A multi-contact bearing includes, an inner race having a rotational axis, an outer race sharing the rotational axis of the inner race, and rolling bearing members constrained between the inner race and the outer race. A number of non-diametrically opposed sets of contact points are positioned on both the outer and inner races. The contact points on each individual race form lines converging to a common vertex on the bearing rotational axis

### FIELD

The present invention relates to an angular contact bearing with a number of rolling member to raceway contact points.

### BACKGROUND

It is common to lubricate the bearings in downhole oilfield tools with drilling mud. Bearings designed for these applications must accept abrasive wear while still maintaining a high load carrying capacity in both radial and axial directions. The initial application of these bearings is a critical time during which the bearings wear themselves in, and set themselves up for even load distribution within a bearing stack. Bearings at the ends of a stack see more radial loads while the internal bearings are loaded up more in thrust. A single contact angle limits a bearing's ability to adjust due to greater sliding friction and loss of internal geometry.

### SUMMARY

There is provided a multi-contact bearing which includes an inner race having a rotational axis, an outer race sharing the rotational axis of the inner race, and rolling bearing members constrained between the inner race and the outer race. A number of non-diametrically opposed sets of contact points are positioned on both the outer and inner races. The contact points on each individual race form lines converging to a common vertex on the bearing rotational axis.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a non-diametrical multi-contact ball bearing with a common vertex on the bearing centre axis.

FIG. 2 is a side elevation view of the bearing illustrated in FIG. 1.

FIG. 3 is a section view of the bearing taken along section lines A-A of FIG. 2.

FIG. 4 is a detailed side elevation view, partially in section of the bearing illustrated in FIG. 3.

FIG. 5 is a view of the internal geometry of the bearing illustrated in FIG. 4.

FIG. 6 is a view of a number of bearings forming a dual direction bearing stack.

### DETAILED DESCRIPTION

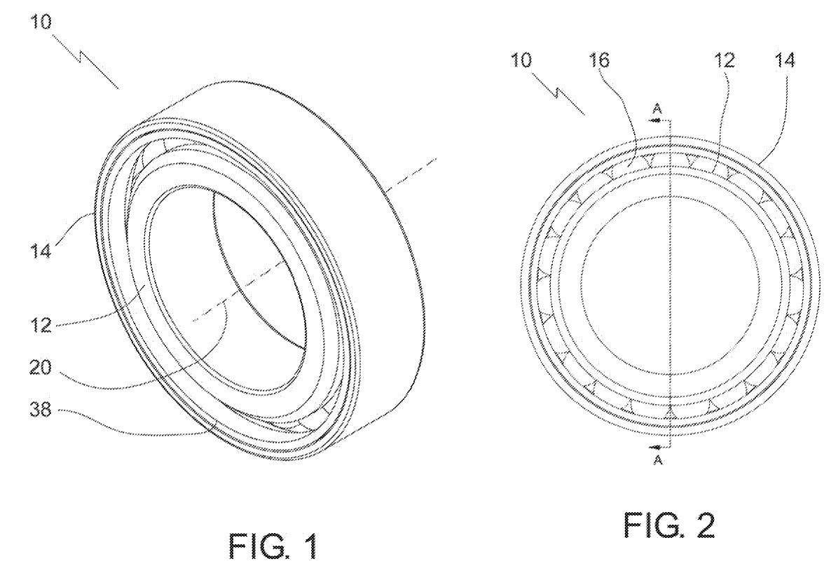

A non-diametrical multi-contact bearing generally identified by reference numeral 10, will now be described with reference to FIG. 1 through FIG. 6. Bearing 10 differs from other multi-contact ball bearings having a number of ball to raceway contact points, in that the contact points are not diametrically opposed, but rather combine to form a true rolling vertex on the rotational axis of the bearing.

Structure and Relationship of Parts:

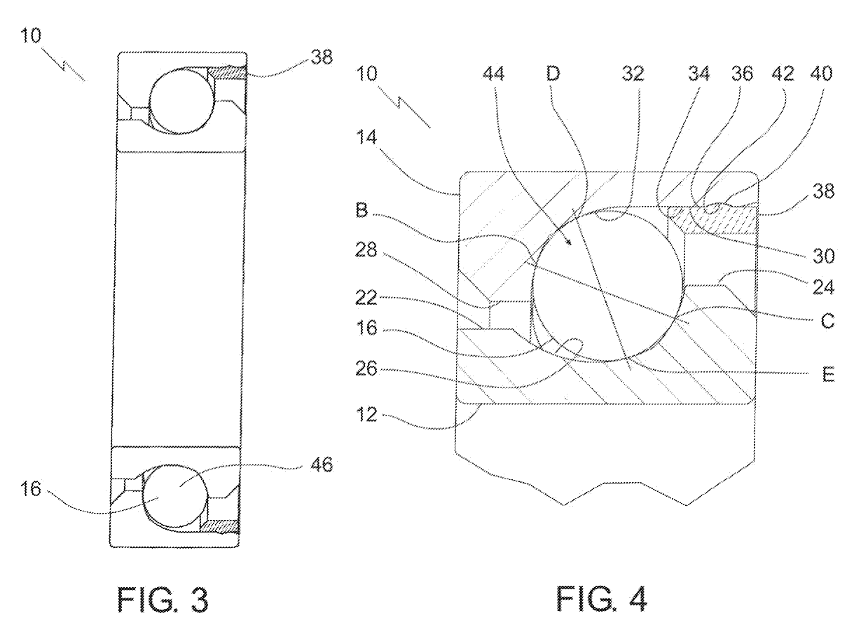

Referring to FIG. 2, there is illustrated a multi-contact bearing 10 consisting of an inner race 12, an outer race 14, and rolling bearing members 16. Referring to FIG. 4, bearing 10 has a number of contact points C, D, B, and E. Referring to FIG. 1, inner race 12 and outer race 14 share a common rotational axis 20. Referring to FIG. 4, inner race 12 has a first shoulder 22, a second shoulder 24, and a rounded inner profile 26. Outer race 14 has a first shoulder 28, a flat end 30, and a rounded inner profile 32. First shoulders 22 and 28 are oriented facing the same side. Shoulders 22, 24, and 28 may be of varying heights. Flat end 30 has a first circumferential profile 34, into which a second circumferential profile 36 of a retainer ring 38 engages. Referring to FIGS. 1 and 3, retainer ring 38 runs three hundred sixty degrees circumferentially around multi-contact bearing 10. Referring to FIG. 4, second circumferential profile 36 has a protrusion 40 that engages a recess 42 of first circumferential profile 34. Rounded inner profiles 26 and 32 together define a bearing member raceway 44. Rounded inner profiles 26 and 32 are rounded acircularly to determine the location of contact points C, D, B, and E. Retainer ring 38 functions similar to second shoulder 24 of inner race 12, preventing rolling bearing member 16, constrained between inner race 12 and outer race 14, from exiting bearing member raceway 44. Rolling bearing members 16 can be any type of rolling element that can be used in a bearing system. In the example shown in FIG. 3, rolling bearing members 16 are balls 46. Balls 46 are generally near-perfect spheres, in order to reduce wear and friction during operation.

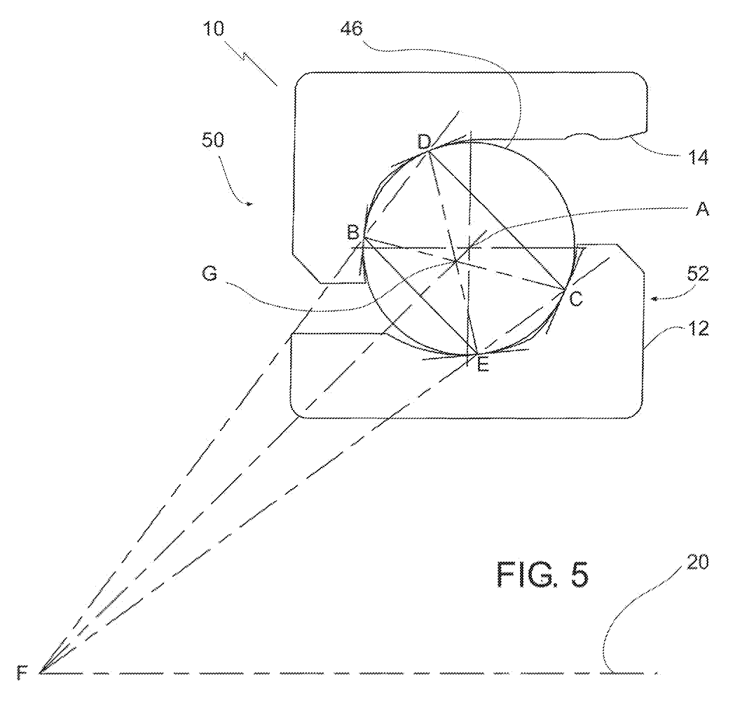

Referring to FIG. 5, there are a number of contact points B, and D between each ball 46 and outer race 14, and a number of contact points C and E between each ball 46 and inner race 12. Contact points C and E, respectively, are mating load supporting points on inner race 12 for each of outer race 14 contact points B and D, respectively, so that a number of load supporting lines BC, DE are created. Each set of matching contact points form a load support line within bearing 10, for example lines BC and DE. The points of each load support line are not diametrically opposed to each other across center A of ball 46, but are arranged so that the contact points on each individual race B and D for outer race 14, and C and E for inner race 12, also form their own lines DBF and CEF with a common vertex F on rotational axis 20 of both races 12 and 14. By making the load support lines BC and DE non-diametrical, and creating common vertex F for the individual race contact point lines DBF and CEF, true rolling with a multiple number of load support contact angles is thus achieved. Load support lines BC and DE intersect within bearing member raceway 44 at point G, point G being any point that is not located at center A of ball 46. The side of bearing 10 where point F projects defines a front face 50 and a rear face 52 of bearing 10.

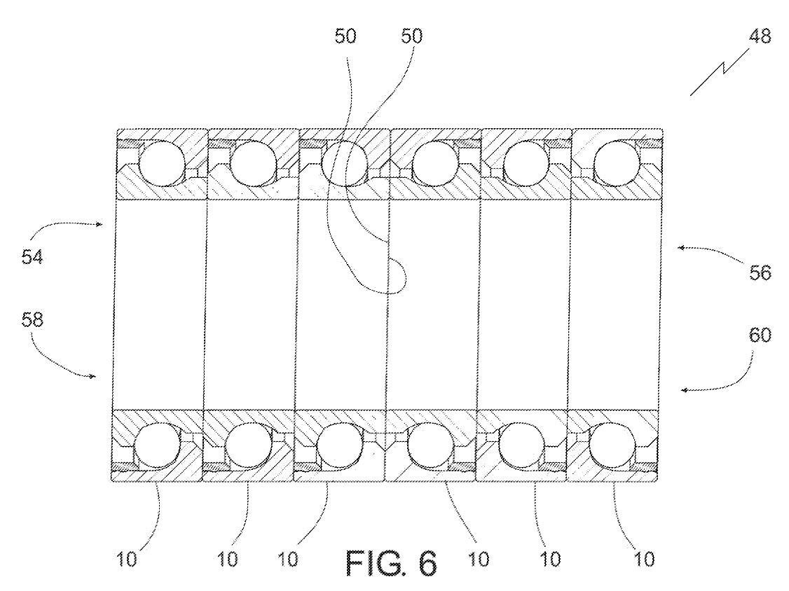

Referring to FIG. 6, an exemplary stack 48 of bearings 10 is illustrated. Stack 48 consists of two sets 54 and 56 of three bearings 10 each. Each bearing 10 of set 54 has its front face 50 oriented towards the right side of the page, and each bearing 10 of set 56 has its front face 50 oriented towards the left side of the page. In this manner, stack 48 achieves true, balanced rolling, with bearings 10 set up well for event load distribution. Bearings 10 located at either end 58 and 60 of stack 48 experience more radial loads, while the internally located bearings 10 are loaded up more in axial thrust.

Advantages:

The bearing, as described above, provides a number of advantages. Each set of contact points provides for true rolling geometry, and a greater combination of radial and thrust capacity. The bearing provides increased radial and thrust capacity over the traditional single angular contact design. It reduces initial wear during the run-in process of a mud lubricated bearing stack. A single contact angle limits a bearing's ability to adjust due to greater sliding friction and loss of internal geometry. A bearing with both a radial and axial orientated load support lines reduces the wear and maintains a truer rolling geometry as the ratio of radial to axial load varies within the stack. In addition, the capacity of the bearing is increased and contact stresses within the bearing are reduced.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A multi-contact bearing, comprising:
an inner race having a rotational axis;
an outer race sharing the rotational axis of the inner race;
rolling bearing members constrained between the inner race and the outer race;
a number of non-diametrically opposed sets of contact points, on both the outer and inner races, wherein the contact points on each individual race form lines converging to a common vertex on the bearing rotational axis.

2. The bearing of claim 1, wherein the rolling bearing members are ball bearings.
